(19) United States
(12) Patent Application Publication
(10) Pub. No.: US 2009/0234490 A1
(43) Pub. Date: Sep. 17, 2009

(54) Smart Machining System and Smart Tool Holder Therefor

(76) Inventors: Christopher A. Suprock, Exeter, NH (US); Jeff Nichols, Dover, NH (US); Robert Jerard, Durham, NH (US); Barry Fussell, Durham, NH (US)

Correspondence Address: ECKERT SEAMANS CHERIN & MELLOTT, 600 GRANT STREET, 44TH FLOOR, PITTSBURGH, PA, 15219, US

(21) Appl. No.: 12/405,513

(22) Filed: Mar. 17, 2009

Related U.S. Application Data
(60) Provisional application No. 61/037,033, filed on Mar. 17, 2008.

(51) Int. Cl. G06F 19/00; B23B 31/00

(52) U.S. Cl. 700/159; 408/16; 408/116; 408/238

(57) ABSTRACT

A smart tool holder is for use with a machine tool platform. The smart tool holder includes a body having a first end and an opposite second end, a processor disposed with the body, and a transceiver disposed with the body and in communication with the processor. The transceiver is structured to communicate with an external receiving device. The first end of the body is structured to be coupled to the machine tool platform and the opposite second end is structured to be selectively coupled to a cutting assembly having a number of sensors. The processor is structured to communicate with the number of sensors when the cutting assembly is coupled to the body. The processor may perform data analysis tasks using model based data analysis, digital filtering, and other techniques. The smart tool holder may suggest changes to the machining process based on two-way communication with a machine tool controller through a receiver or interface device.

### CROSS-REFERENCE TO RELATED APPLICATION

The present application claims priority from U.S. Provisional Patent Application Ser. No. 61/037,033 filed Mar. 17, 2008, the disclosure of which is incorporated herein by reference.

### BACKGROUND

1. Field of the Invention

The invention relates generally to tool holder assemblies, and, more particularly, to smart tool holders for use with machine tool platforms. The invention also relates to a smart tool assembly for use with a machine tool platform. The invention further relates to a smart machining system employing a smart tool holder.

2. Background Information

Annual U.S. expenditures on machining operations are estimated to be in excess of $200 billion. Accordingly, there exists a great demand for improved cutting tools and machining methods in order to minimize such expenditures. In December 2007, the National Institute of Standards and Technology (NIST) hosted a workshop on “Smart Machine Tools” organized by the Integrated Manufacturing Technology Initiative (IMTI) association to “assess the needs, opportunities, and requirements for increasing the intelligence of machine tools for material removal.” Two of the top priorities, as voted by the participants, were to establish physics based process models for a smart machine tool testbed and to capture and understand the information necessary to determine machine conditions.

In order for a machining monitoring system, such as an end mill condition monitoring system, to be widely accepted by industry, the deployment onto shop floor machinery must be low cost, noninvasive, and cause no disruption of the machining envelope. However, a monitoring system typically requires data collection sensors to be located on or in the machine. Unfortunately, many sensor types are high in cost, are invasive to the machining envelope, and/or are difficult to deploy.

Historically, the ability to record in-process data about the response of the tool tip has been limited to data collected from sensors at locations physically distant from the cutting process. Often, these sensors are mounted on the material workpiece or the machine spindle. However, the complexity of the end milling system causes noisy transmission of vibration between the tool tip and the location of a traditionally mounted stationary sensor. This fact increases the difficulty of analyzing the dynamic motion of the tool tip and decreases the resolution on subtle phenomena of interest. In order to fully understand dynamic end milling problems such as tool chatter, wear, or run out, it is necessary to observe the tool tip response characteristics at their source during the cutting process.

A known instance of a non-invasive sensor is a power monitor located on a spindle drive motor of a machine tool platform. Although non-invasive and cost effective, sensors such as power monitoring do not provide sufficient bandwidth to capture many important details of the machining process. Additionally, many known condition monitoring techniques require sensors such as bed-type dynamometers which are largely impractical. From a research perspective, such sensor types are necessary for the development and validation of robust system models. However, in real world application, the sensing approach should accommodate cost, ease of setup, and performance.

There is, therefore, room for improvement in monitoring of machining systems, particularly in monitoring of cutting tools and the equipment used therefor.

### SUMMARY OF THE INVENTION

These needs and others are met by embodiments of the invention, which are directed to a smart tool holder for use with a machine tool platform, a smart tool assembly for use with a machine tool platform, and a smart machining system employing a smart tool holder.

As one aspect of the invention, a smart tool holder is for use with a machine tool platform. The smart tool holder comprises a body having a first end and an opposite second end, a processor disposed with the body, and a transceiver disposed with the body and in communication with the processor. The transceiver is structured to communicate with an external receiving device. The first end of the body is structured to be coupled to the machine tool platform and the opposite second end of the body is structured to be selectively coupled to a cutting assembly having a number of sensors. The processor is structured to communicate with the number of sensors when the cutting assembly is coupled to the body.

The body may include a first electrical connector disposed at or near the opposite second end, the first electrical connector being electrically connected with the processor. The cutting assembly may comprise a rotary cutting tool having a first end selectively coupled to the opposite second end of the body and an opposite second end structured to engage a work piece. The first end may include a second electrical connector electrically connected with the number of sensors of the cutting assembly. The first electrical connector may be electrically connected with the second electrical connector when the cutting assembly is coupled to the body.

The transceiver may be a wireless transceiver.

The processor may comprise a microprocessor, microcontroller, or digital signal processor unit. The processor may comprise a number of data processing algorithms and models disposed therein.

The body may further comprise a power supply disposed therewith. The power supply may be rechargeable and may comprise a charging aperture having a removable cover, the charging aperture may be structured to connect to an external charging device. The power supply may be rechargeable by inductive charging.

As another aspect of the invention, a smart tool assembly is for use with a machine tool platform. The smart tool assembly comprises a smart tool holder and a cutting assembly. The smart tool holder comprises a body having a first end structured to be coupled to the machine tool platform and an opposite second end, a processor disposed with the body, and a transceiver disposed with the body and in communication with the processor. The transceiver being structured to communicate with an external receiving device. The cutting assembly having a first end and a second end, the first end being selectively coupled to the opposite second end of the body of the smart tool holder and the second end of the cutting assembly being structured to engage a workpiece. The cutting assembly having a number of sensors in communication with the processor when the cutting assembly is coupled to the smart tool holder.

The opposite second end of the body of the tool holder may comprise a first electrical connector and the first end of the cutting assembly may comprise a second electrical connector, the first electrical connector and the second electrical connector being positioned to cooperatively electrically and mechanically engage when the cutting assembly is coupled to the tool holder thus allowing communication between the number of sensors and the processor.

The cutting assembly may comprise a rotary cutting tool having a first end coupled to the opposite second end of the body of the tool holder and an opposite second end structured to engage a workpiece. The rotary cutting tool may comprise one of an endmill, shell mill, face mill, drilling tool, boring tool and other metal cutting tooling.

The cutting assembly may comprise an insert holder having a number of cutting inserts selectively coupled thereto. The number of sensors may be structured to sense at least one of temperature, acceleration, force, and torque.

The smart tool holder may further comprise a power supply disposed therewith.

As a further aspect of the invention, a smart tool holder is for use with a machine tool platform. The smart tool holder comprises a body having a first end and an opposite second end, a processor disposed with the body, a number of sensors disposed with the body and in communication with the processor, and a transceiver disposed with the body and in communication with the processor. The processor being structured to communicate with an external receiving device. The first end of the body being structured to be selectively coupled to the machine tool platform and the opposite second end of the body being structured to be selectively coupled to a cutting assembly.

The transceiver may be a wireless transceiver.

The processor may comprise a microprocessor, microcontroller, or digital signal processing unit. The processor may comprise a number of data processing algorithms and models disposed therein.

The body may further comprise a power supply disposed therewith. The power supply may be rechargeable and may comprise a charging aperture having a removable cover. The charging aperture may be structured to connect to an external charging device. The power supply may be rechargeable by inductive charging.

The number of sensors may be structured to sense at least one of temperature, acceleration, force, and torque.

As yet another aspect of the invention, a smart machining system is for machining a workpiece. The smart machining system comprises a machine tool platform, a smart tool holder, a cutting assembly, and an external receiver device. The smart tool holder comprises a body having a first end being selectively coupled to the machine tool platform and an opposite second end, a processor disposed with the body, and a transceiver disposed with the body and being in communication with the processor. The transceiver being structured to communicate with an external receiving device. The cutting assembly having a first end and a second end, the first end being selectively coupled to the opposite second end of the body of the tool holder and the second end of the cutting assembly being structured to engage a workpiece. The cutting assembly has a number of sensors in communication with the processor when the cutting assembly is coupled to the smart tool holder.

The machine tool platform may comprise a machine tool controller, wherein the external receiver device provides a signal to the machine tool controller. The transceiver and the external receiver device may communicate wirelessly.

### BRIEF DESCRIPTION OF THE DRAWINGS

A full understanding of the invention can be gained from the following description of the preferred embodiments when read in conjunction with the accompanying drawings in which:

FIG. 1 is an isometric view of a smart tool holder assembly in accordance with an embodiment of the invention;

FIG. 2 is an exploded isometric view of the smart tool assembly of FIG. 1;

FIG. 3 is an isometric view of another smart tool assembly in accordance with another embodiment of the invention;

FIG. 4 is an exploded isometric view of the smart tool assembly of FIG. 3;

FIG. 5 is an isometric view of yet another smart tool assembly in accordance with a further embodiment of the invention;

FIG. 6 is a schematic diagram in block form of a smart machining system in accordance with an embodiment of the invention;

FIG. 7 is a schematic diagram in block form of another smart machining system in accordance with another embodiment of the invention; and

FIG. 8 is a schematic diagram in block form of a further smart machining system in accordance with a further embodiment of the invention.

### DESCRIPTION OF THE PREFERRED EMBODIMENTS

As employed herein, the term “number” shall mean one or an integer greater than one (i.e., a plurality).

As employed herein, the term “processor” means a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus. Example embodiments consists of 8 bit and 32 bit microprocessors with internal DSP (digital signal processing) commands. These processing units are supplemented by high bandwidth digital to analog converters. The processing unit is also supplemented by a specialized coprocessor for controlling digital radio transmission, communication error checking, synchronization with the receiving device, and communications channel operations.

As employed herein, the term “sensor” means a device or apparatus that responds to a physical stimulus (e.g., without limitation, temperature, vibration, acceleration, force, torque, sound, hoop stress, infrared emission, dynamic optical stimulus (interferometer)) and outputs a resulting impulse or signal (e.g., without limitation, for monitoring, measurement and/or control). Of specific interest are semiconductor based sensors for measurement of torsion strain, bending strain, axial strain, and temperature. For example, sensors consisting of P (positive doped) or N (negative doped) type silicon materials. In an embodiment, sensors consisting of P type silicon have been made using the Czochralski process. In another embodiment, N-type silicon sensors are deployed to match sensor resistance-temperature coefficient to the linear expansion coefficient of the tool holder, minimizing temperature related drift in a torsion strain signal. Semiconductor sensor examples include, without limitation, Micron Instruments “SSGH” and Kyowa “KSN” products.

As employed herein, the term “smart” means operating by automation; or including or employing a number of processors, data processing algorithms, model-based decision making, and/or sensors. The term “smart” also refers to the ability of the tool holder to establish and maintain two-way communication with a machine controller or a receiving device.

As employed herein, the term “with” means on, partially on, partially within, or within an associated object.

Directional phrases used herein, such as, for example, left, right, front, back, top, bottom and derivatives thereof, relate to the orientation of the elements shown in the drawings and are not limiting upon the claims unless expressly recited therein. Identical parts are provided with the same reference number in all drawings.

The smart tool holder described herein overcomes shortcomings of known solutions by providing a robust, real-time sensor interface system that can provide tool tip sensor data for process condition monitoring during metal cutting by transmitting acceleration and/or force data directly from an end mill tool tip or from individual cutting inserts. Such capability is advantageous, in order to advance physical modeling and condition monitoring techniques for an end mill system. Furthermore, the smart tool holder ascends known sensor techniques by implementing onboard data analysis and model based decision making, suggesting changes in the machining conditions through a two-way communication with a CNC (Computer Numerical Control) machine tool.

Condition monitoring includes tool wear, runout, and stability evaluation. The example smart tool holder described herein enables accurate determination of CNC metal cutting system dynamics in order that cutting forces and, ultimately, part quality can be estimated in-process. Dynamic effects can result in tool forces and deflections an order of magnitude higher than the static deflections. Therefore, the smart tool holder can provide data for on-line characterization of machine tool dynamics to quantify their effect on part accuracy, user safety, and process evaluation.

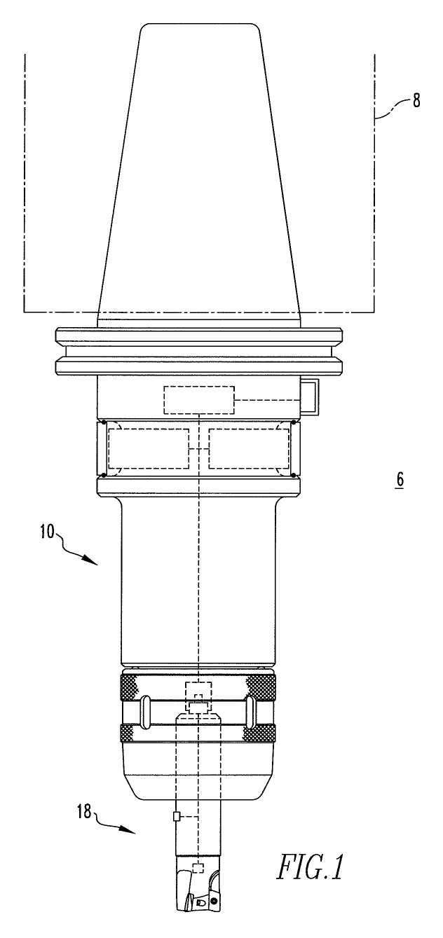

The example tool holders 10 and 10″ depicted in FIGS. 1-5 and described below were constructed from a High Performance Milling Chuck manufactured by Kennametal Inc. of Latrobe, Pa. It is to be appreciated, however, that the invention is not intended to be limited in any manner to such tool holders. Other suitable tool holders (e.g., without limitation, Shrink Fit Tool Holders, Weldon Shank Set Screw Tool Holders, Collet Tool Holders, ISO Capto Tool Holders, Vibration Damped Tool Holders, Face Milling Adapters, Thread Milling Tool Holders, Solid Carbide/HSS Milling Tools, Precision Hole Tool Holders, Tooling Length Extension Units, Turning and Lathe tools) may be modified and employed without departing from the scope of the present invention.

Referring to FIG. 1, an example smart tool holder assembly 6 for use with a machine tool platform 8 (shown in phantom line drawing) in performing machining operations on a workpiece (not shown) in accordance with one non-limiting embodiment of the invention is shown. The smart tool holder assembly 6 includes a smart tool holder 10 and a removable cutting assembly 18.

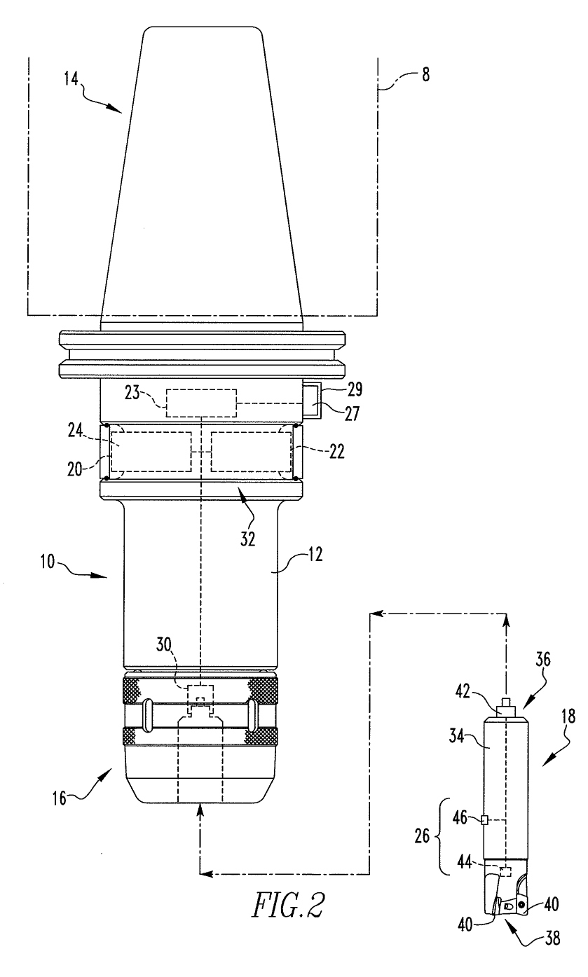

As shown in FIG. 2, the smart tool holder 10 includes a body 12 having a first end 14 and an opposite second end 16. The first end 14 of the body 12 is structured to be selectively coupled to the machine tool platform 8. Such coupling of the first end 14 of the smart tool holder 10 to the machine tool platform 8 may readily be accomplished by for example, without limitation, standard spindle tapers such as the CV50 geometry shown, CV40, HSK, BT40, BT30, ISO Capto, among other industry standard spindle geometries available on modern machine tools.

The opposite second end 16 of body 12 is structured to selectively couple one of a variety of potential cutting assemblies 18. Such coupling of the second end 16 of the smart tool holder 10 to the cutting assembly 18 may readily be accomplished by for example, without limitation, shrink fit, precision chuck, collet, weldon shank, among various available proprietary tool holding interface geometries.

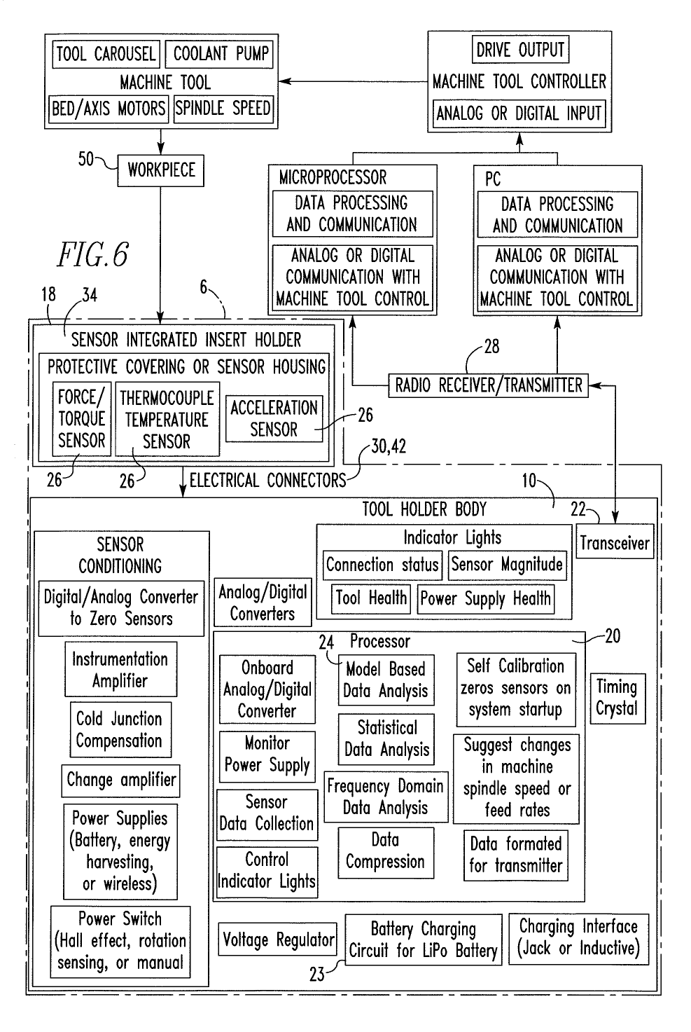

Body 12 of smart tool holder 10 can include a number of electrical components as shown, for example, in FIGS. 6-8. More particularly, body 12 includes a processor 20, a transceiver 22, and power supply 23 disposed on, partially on, within, or partially within body 12. In some embodiments, body 12 may also include a number of sensors (not shown in FIG. 1) as will be discussed further below. Processor 20 includes one or more of an internal and external memory (not shown). The processor 20 may be, for example and without limitation, a microprocessor (μP) that interfaces with the memory or a standalone DSP (digital signal processing) unit. The memory may be any one or more of a variety of types of internal and/or external storage media such as, without limitation, RAM, ROM, EPROM(s), EEPROM(s), FLASH, and the like that provide a storage register, i.e., a machine readable medium, for data storage in a similar fashion to an internal memory storage of a computer, and can be volatile memory or nonvolatile memory. The memory has stored therein a number of routines 24 that are executable by the processor 20. One or more of the routines 24 implement a software-based analysis system that is operable to receive input from one or more sensors 26 (discussed below) and provide output to the transceiver 22 for further transmission outside of the body 12 of the smart tool holder 10. It is to be appreciated that the routines 24 shown in FIGS. 6-8 are provided for example purposes only and are not meant to be limiting upon the scope of the present invention. Routines 24 may, for example, and without limitation, perform data processing/analysis techniques such as: estimating and predicting chatter frequencies, suggesting stable spindle speeds, wear monitoring, and suggesting feed rate overrides. Such techniques, for example, may commonly employ the methods of: Kalman filters, formant frequency tracking/LPC (Linear Predictive Coding), autoregressive models, mechanistic cutting force models, FIR (Finite Impulse Response) and IIR (Infinite Impulse Response) digital filters, Fourier spectral analysis, and statistical data analysis.

Transceiver 22 preferably comprises a digital wireless transceiver, for example, without limitation, a FHSS (Frequency Hopping Spread Spectrum) transceiver, a frequency agility transceiver, or a digital infrared transceiver employing for example, without limitation, the methods of auto retransmission, error correction, and ISM (Industrial, Scientific, and Medical) band frequencies. Transceiver 22 is structured to send and receive signals from a receiver/transceiver device 28 (FIGS. 6-8) positioned external to the smart tool holder 10. The receiver/transceiver device 28 may comprise a transceiver module interfaced with analog or digital outputs and integrated with a data analysis processing unit consisting of a PC, microprocessor, or DSP (digital signal processing) hardware.

Generally the system transceiver 22 will either send all of the data in a streaming fashion (high bandwidth), or, it will send analysis results in a condensed form (low bandwidth). A user of the system would have the option of requesting either. High bandwidth data is sent at a rate on the order of about 10-20 kHz at 16 bit resolution. Low bandwidth analysis results are sent at a rate on the order of about 1 kHz. A third option allows the transceiver to be turned off to set the tool in data logging mode, wherein the tool collects and stores information for later retrieval. In such case, such storage and later retrieval of data may also be accomplished through use of a removable memory device (not shown) included additional to, or in place of, transceiver device 22. Communication with the smart tool holder 10 is preferably two-way since process parameters (e.g., without limitation, cut feed rates, spindle speed, positions, tool engagements) may be sent to the smart tool holder 10.

Power supply 23 provides electrical power to processor 20 and as needed to other electrical components of the smart tool holder 10. Power supply 23 may include replaceable batteries or replaceable rechargeable batteries that may be recharged using an external charging station (not shown). Additionally, power supply 23 may include internal rechargeable batteries or an internal super capacitor. Examples of foreseeable recharging sources for such internal power supplies include, without limitation, inductive charging, near field magnetic resonant coupling (such as WiTricity), a physical charging jack, photovoltaics (solar panels), vibration energy harvesting (such as piezoelectric parasitic generators), inertial energy harvesting (through a dynamo or other generator), generators designed to harvest power from the flow of through-coolant, and generators operating from dynamic air movement around the rotating tool holder. Power transmission through directed radio frequency emission or lasers may also be employed. In the embodiments shown in FIGS. 1-4, the power supply 23 may be recharged through the use of an external charging jack (not shown) that would be coupled to a charging aperture 27 provided on the body 12 of the smart tool holder 10. During machining operations, the charging aperture 27 may be covered with a protective cover or cap 29 that may readily be removed when charging operations are to be performed, such as when the smart tool holder assembly 6 is not engaged in machining operations.

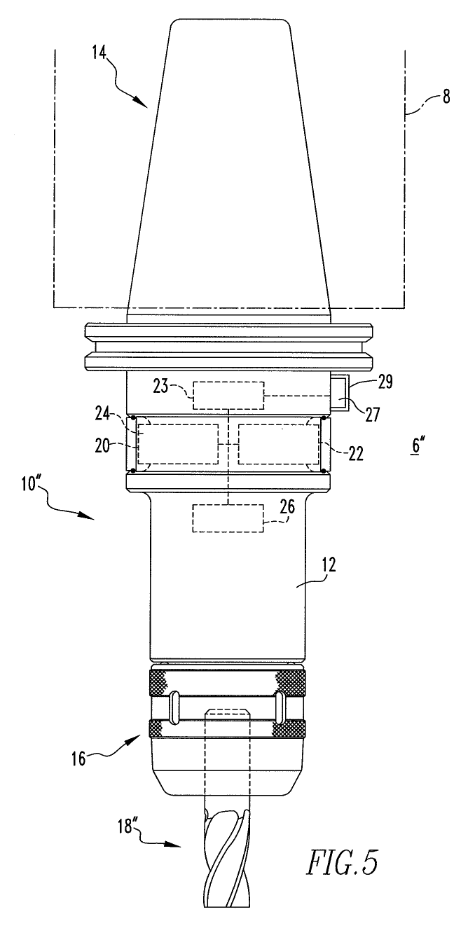

Body 12 further includes an electrical connector 30 electrically connected to processor 20 and disposed generally at or near the opposite second end 16. Another embodiment of the smart tool holder 10″ (shown in FIG. 5) contains sensors disposed on the body 12 and does not contain an electrical interface to the tool. Such embodiment as shown in FIG. 5 does not interfere with through coolant use and can sense data from any standard (non-sensor integrated) cutting tools. In the embodiments depicted in FIGS. 1-4, processor 20 and transceiver 22 are housed within a sealed housing 32 on body 12. Processor 20 and transceiver 22 are electrically connected such that processor 20 may send and receive information from transceiver 22.

Body 12 may further comprise a number of lights or other indicia (not numbered) for providing one or more visible indications of the status of the smart tool holder 10. Such indications may be employed to inform an operator of such condition as, for example, without limitation, the presence of sensor outputs, tool condition, power status, displaying the arc length of tool engagement, and displaying ‘stationary’ images or text on the tool holder by illuminating at the frequency of tool holder rotation.

The smart tool holder assembly 6 shown in FIGS. 1 and 2 depicts an embodiment in which the cutting assembly 18 comprises an insert holder 34 of generally longitudinal shape having a first end 36 and a generally opposite second end 38, the first end 36 being structured to be selectively coupled to the opposite second end 16 of the body 12 of smart tool holder 10 (as shown in FIG. 1). Insert holder 34 includes a number of cutting inserts 40 selectively coupled generally at or near the opposite second end 38, a number of sensors 26 disposed at selected locations on, partially within, or within the insert holder 34, and an electrical connector 42 preferably disposed at or near the first end 36. The electrical connector 42 is electrically connected to each of the number of sensors 26 and is structured to cooperatively mechanically and electrically engage the electrical connector 30 of the smart tool holder 10 when the cutting assembly 18 is coupled to the smart tool holder 10 (as shown in FIG. 1). Each of the cutting inserts 40 is structured to engage a workpiece 50 (FIGS. 6-8) during machining operations.

As shown in FIG. 2, the number of sensors 26 may include a tool tip accelerometer 44 embedded within the insert holder 34 and a force or torque sensor 46 disposed at or near a surface of the insert holder 34. It is to be readily appreciated that such sensors 26 and locations are given for example purposes only and are not intended to limit the scope of the invention. In the case of an accelerometer, it is important to locate the sensor as close to the tool tip as possible in order to observe the movement dynamics of the tool tip without requiring the methods of RCSA (receptance coupling substructure analysis).

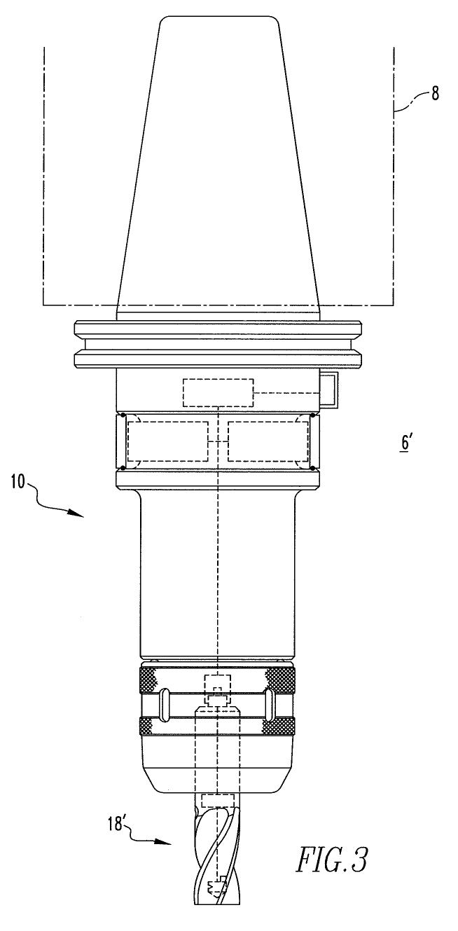

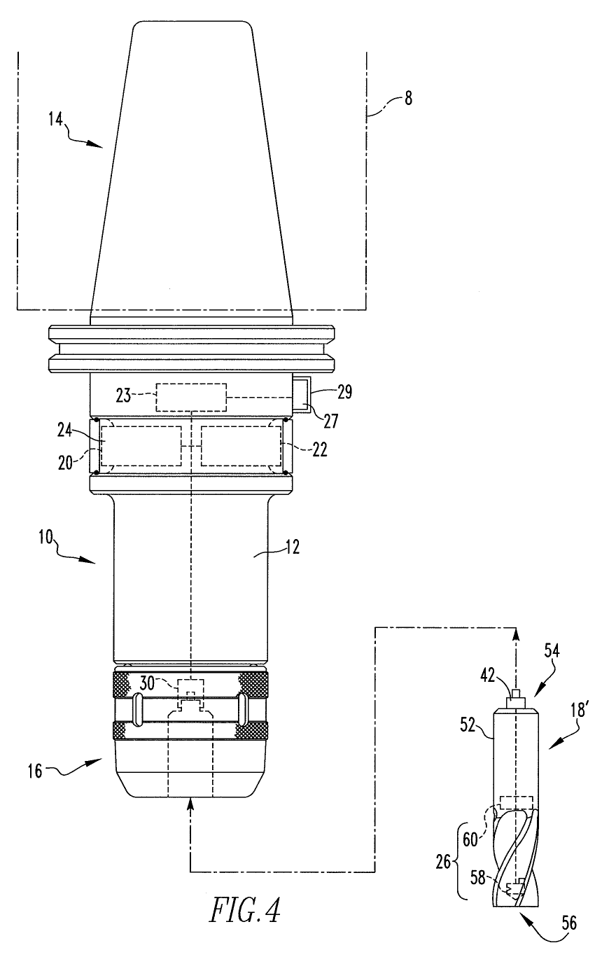

The smart tool holder assembly 6′ shown in FIGS. 3 and 4 depicts an embodiment in which the cutting assembly 18′ comprises a rotary end mill cutting tool 52 (shown in FIG. 4) of generally longitudinal shape having a first end 54 and a generally opposite second end 56, the first end 54 being structured to be selectively coupled to the opposite second end 16 of the body 12 of smart tool holder 10 (as shown in FIG. 3) and the second end being structured to engage a workpiece 50 (FIGS. 6-8) during machining operations. Cutting tool 52 further includes a number of sensors 26 disposed at selected locations on or within the cutting tool 52, and an electrical connector 42 preferably disposed at or near the first end 54. The electrical connector 42 is electrically connected to each of the number of sensors 26 and is structured to cooperatively mechanically and electrically engage the electrical connector 30 of the smart tool holder 10 when the cutting assembly 18′ is coupled to the smart tool holder 10 (as shown in FIG. 3).

As shown in FIG. 4, the number of sensors 26 may include a tool tip accelerometer 58 embedded within the cutting tool 52 and a force or torque sensor 60 disposed at or near a surface of the cutting tool 52. It is to be readily appreciated that such sensors 26 and locations are given for example purposes only and are not intended to limit the scope of the invention.

The smart tool holder assembly 6″ shown in FIG. 5 depicts a further embodiment in which the smart tool holder 10″ itself includes a number of sensors 26 disposed therewith. Sensors 26 may include, for example without limitation, sensors for detecting torque, bending force, axial force, hoop stress, and acceleration. In this embodiment, cutting assembly 18″ is shown as a known rotary end mill cutting tool. However it is to be appreciated that other cutting tools may readily be employed as cutting assembly 18″ (e.g., without limitation, endmills, shell mills, face mills, drilling tools, boring tools, and other metal cutting tooling).

Furthermore, it is to be readily appreciated that such sensors 26 and locations are given for example purposes only and are not intended to limit the scope of the invention.

Having thus described some example tool holder assemblies 6, 6′, and 6″, an example smart machining system employing the tool holder assembly 6 will now be described. FIG. 6 shows a smart machining system employing a smart tool assembly 6 utilizing insert holder 34 such as shown in FIGS. 1 and 2 having a number of cutting inserts 40 that machine the workpiece 50. During machining, the sensors 26 provide data to the processor 20 which then analyzes the data using one or more of the routines 24. The data resulting from such analysis by the processor 20 is then transmitted by the transceiver 22 to receiver/transmitter device 28 external to the smart tool holder 10 for observation or potential further analysis. In addition to transmitting data from the smart tool holder 10, transceiver 22 may further be used to receive data transmitted to the smart tool holder 10 by the external receiver/transmitter device 28 or by another communication device or apparatus (not shown). Such data transmitted to the smart tool holder 10 may include data sent prior to, during, or after machining operations (e.g., without limitation, cut feed rates, spindle speed, positions, tool engagements).

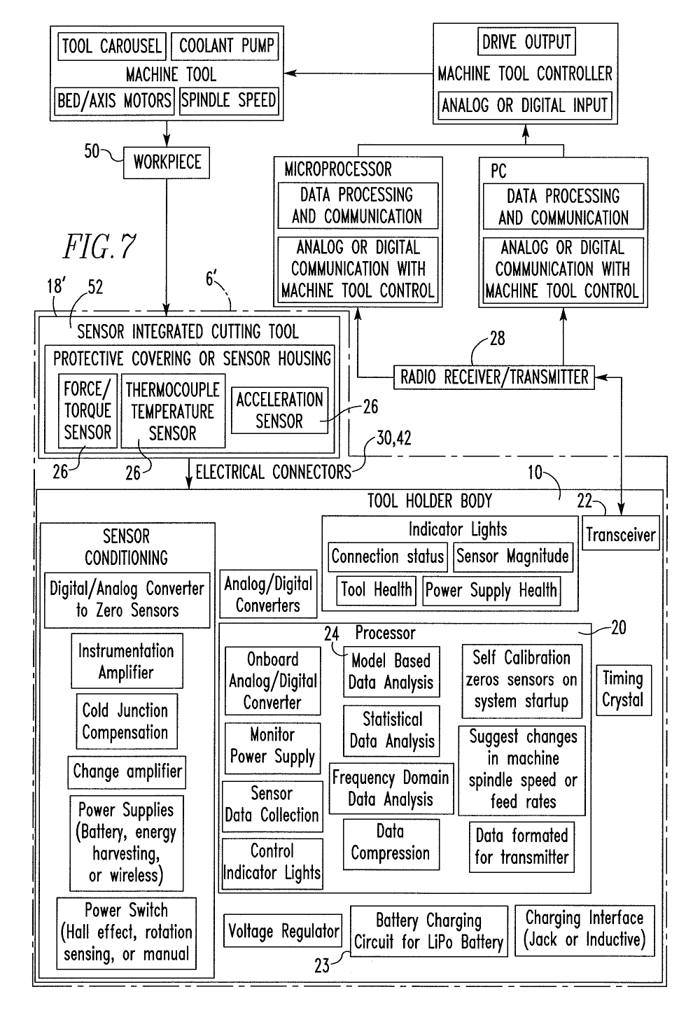

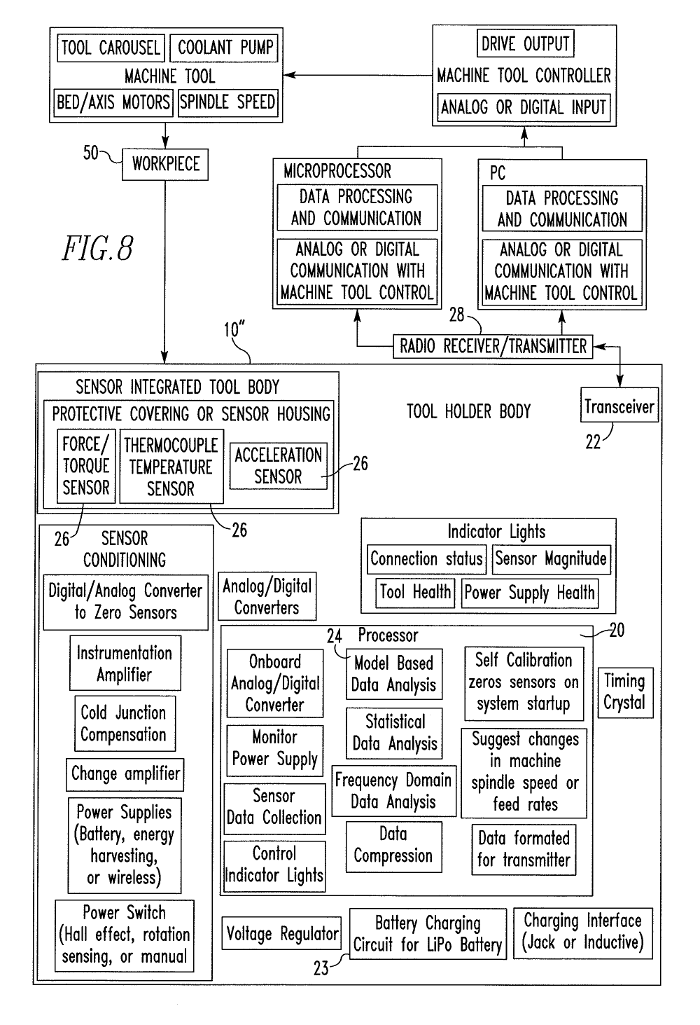

It is to be readily appreciated that FIG. 7 shows a smart machining system employing a smart tool assembly 6′, such as shown in FIGS. 3 and 4, and which operates substantially the same as the system previously described in regard to FIG. 6. Likewise, FIG. 8 shows a smart machining system employing a smart tool assembly 6″, such as shown in FIG. 5, and which also operates substantially the same as the system previously described in regard to FIG. 6. Accordingly, a detailed discussion of FIGS. 7 and 8 is not provided herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A smart tool holder for use with a machine tool platform, the smart tool holder comprising:
a body having a first end and an opposite second end;
a processor disposed with the body; and
a transceiver disposed with the body and being in communication with the processor, the transceiver being structured to communicate with an external receiving device,
wherein the first end of the body is structured to be selectively coupled to the machine tool platform, wherein the opposite second end of the body is structured to be selectively coupled to a cutting assembly having a number of sensors, and wherein the processor is structured to communicate with the number of sensors when the cutting assembly is coupled to the body.

2. The smart tool holder of claim 1 wherein the body includes a first electrical connector disposed at or near the opposite second end, the first electrical connector being electrically connected with the processor;
wherein the cutting assembly comprises a rotary cutting tool having a first end selectively coupled to the opposite second end of the body and an opposite second end structured to engage a work piece, the first end including a second electrical connector electrically connected with the number of sensors of the cutting assembly; and
wherein the first electrical connector is structured to be electrically connected with the second electrical connector when the cutting assembly is coupled to the body.

3. The smart tool holder of claim 1 wherein the transceiver is a wireless transceiver.

4. The smart tool holder of claim 1 wherein the processor comprises a microprocessor, microcontroller, or digital signal processor unit

5. The smart tool holder of claim 1 wherein the processor comprises a number of data processing algorithms and models disposed therein.

6. The smart tool holder of claim 1 wherein the body further comprises a power supply disposed therewith.

7. The smart tool holder of claim 6 wherein the power supply is rechargeable and comprises a charging aperture having a removable cover, the charging aperture being structured to connect to an external charging device.

8. The smart tool holder of claim 6 wherein the power supply is rechargeable by inductive charging.

9. A smart tool assembly for use with a machine tool platform, the smart tool assembly comprising:
a smart tool holder comprising:
a body having a first end and an opposite second end, the first end structured to be coupled to the machine tool platform;
a processor disposed with the body; and
a transceiver disposed with the body and being in communication with the processor, the transceiver being structured to communicate with an external receiving device; and
a cutting assembly having a first end and a second end, the first end being selectively coupled to the opposite second end of the body of the smart tool holder and the second end of said cutting assembly being structured to engage a workpiece, the cutting assembly having a number of sensors in communication with the processor when the cutting assembly is coupled to the smart tool holder.

10. The smart tool assembly of claim 9 wherein the opposite second end of the body of the tool holder comprises a first electrical connector, wherein the first end of the cutting assembly comprises a second electrical connector, and wherein the first electrical connector and the second electrical connector are positioned to cooperatively electrically engage when the cutting assembly is coupled to the tool holder thus allowing communication between the number of sensors and the processor.

11. The smart tool assembly of claim 10 wherein the cutting assembly comprises a rotary cutting tool having a first end coupled to the opposite second end of the body of the tool holder and an opposite second end structured to engage a work piece.

12. The smart tool assembly of claim 11 wherein the rotary cutting tool comprises one of an endmill, shell mill, face mill, drilling tool, boring tool and other metal cutting tooling.

13. The smart tool assembly of claim 10 wherein the cutting assembly comprises an insert holder having a number of cutting inserts selectively coupled thereto.

14. The smart tool assembly of claim 9 wherein the number of sensors are structured to sense at least one of temperature, acceleration, force, and torque.

15. The smart tool assembly of claim 9 wherein the transceiver comprises a wireless transceiver.

16. The smart tool assembly of claim 9 wherein the processor is a microprocessor, microcontroller, or digital signal processor unit.

17. The smart tool assembly of claim 9 wherein the smart tool holder further comprises a power supply disposed therewith.

18. The smart tool assembly of claim 17 wherein the power supply is rechargeable and comprises a charging aperture having a removable cover, said charging aperture being structured to connect to an external charging device.

19. The smart tool assembly of claim 17 wherein the power supply is rechargeable by inductive charging.

20. A smart tool holder for use with a machine tool platform, the smart tool holder comprising:
a body having a first end and an opposite second end;
a processor disposed with the body;
a number of sensors disposed with the body and being in communication with the processor; and
a transceiver disposed with the body and being in communication with the processor, the transceiver being structured to communicate with an external receiving device,
wherein the first end of the body is structured to be selectively coupled to the machine tool platform, wherein the opposite second end of the body is structured to be selectively coupled to a cutting assembly.

21. The smart tool holder of claim 20 wherein the transceiver is a wireless transceiver.

22. The smart tool holder of claim 20 wherein the processor comprises a microprocessor, microcontroller, or digital signal processing unit.

23. The smart tool holder of claim 20 wherein the processor comprises a number of data processing algorithms and models disposed therein.

24. The smart tool holder of claim 20 wherein the body further comprises a power supply disposed therewith.

25. The smart tool holder of claim 24 wherein the power supply is rechargeable and comprises a charging aperture having a removable cover, the charging aperture being structured to connect to an external charging device.

26. The smart tool holder of claim 24 wherein the power supply is rechargeable by inductive charging.

27. The smart tool holder of claim 20 wherein the number of sensors are structured to sense at least one of temperature, acceleration, force, and torque.

28. A smart machining system for machining a workpiece, the smart machining system comprising:
a machine tool platform;
a smart tool holder comprising:
a body having a first end and an opposite second end, the first end being selectively coupled to the machine tool platform;
a processor disposed with the body; and
a transceiver disposed with the body and being in communication with the processor;
a cutting assembly having a first end and a second end, the first end being selectively coupled to the opposite second end of the body of the smart tool holder and the second end of said cutting assembly being structured to engage a workpiece, the cutting assembly having a number of sensors in communication with the processor when the cutting assembly is coupled to the smart tool holder; and
an external receiver device in communication with the transceiver.

29. The smart machining system of claim 28 wherein the machine tool platform comprises a machine tool controller, and wherein the external receiver device provides a signal to the machine tool controller.

30. The smart machining system of claim 28 wherein the transceiver and the external receiver device communicate wirelessly.

31. The smart machining system of claim 28 wherein smart tool holder is able to cease communications through the transceiver and instead record information for later retrieval and analysis.
